(19) United States
(12) Patent Application Publication
(10) Pub. No.: US 2015/0368375 A1
(43) Pub. Date: Dec. 24, 2015

(54) Methods For Making Crosslinked Ultra High Molecular Weight Polyethylene

(71) Applicant: Biomet Manufacturing, LLC, Warsaw, IN (US)

(72) Inventors: William Rodgers, III, Warsaw, IN (US); Jordan H. Freedman, Fort Wayne, IN (US)

(21) Appl. No.: 14/313,679

(22) Filed: Jun. 24, 2014

(51) Int. Cl. C08F 10/02; C08K 5/17; C08L 23/06; C08K 5/1545

(52) U.S. Cl. CPC C08F 10/02; C08K 5/1545; C08K 5/17; C08L 23/06

(57) ABSTRACT

Method of preparing a crosslinked oxidation resistant ultrahigh molecular weight polyethylene polymer (UHMWPE) involves 1) forming a blend containing UHMWPE powder, a crosslinker, and optionally an antioxidant; 2) applying first conditions of pressure and heat to consolidate the UHMWPE and 3) applying second conditions of heat to activate the crosslinker and crosslink the consolidated UHMWPE. The crosslinker activates at high temperature and is peroxide free.

### INTRODUCTION

A high temperature melting process for UHMWPE involves heating at a temperature of 200° C. and higher, in conjunction with the use of antioxidants and with subsequent radiation for crosslinking. Benefits of high temperature melting are said to be attributable to a combination of thermally induced chain scissions and increased cohesion of UHMWPE resin particles within the polymer. The latter is understood and referred to as a decrease in Type 2 fusion defects. Within normal melt processed UHMWPE, there remains a history and interfacial boundary region originating from the interfaces of the powder resin particles. This history is not completely removed during melt processing. Type 2 fusion defects tend to be found in UHMWPE materials because the polymer has a high viscosity, with concomitant slow self-diffusion in the molten state.

The use of peroxides for crosslinking UHMWPE is known, but involves difficulty in maintaining oxidative stability in the material. Further, the peroxides tend to activate at the same temperatures required for consolidation of UHMWPE resin particles.

Antioxidants have also been used during UHMWPE processing. However, industry standard antioxidants such as Vitamin E tend to impede the crosslinking carried out after doping with the antioxidant. There remains a need in the industry for improved methods of preparing oxidation resistant crosslinked UHMWPE polymers.

### SUMMARY

Some drawbacks in the prior art are overcome by providing a method of preparing a crosslinked oxidation resistant ultrahigh molecular weight polyethylene polymer (UHMWPE), such as for use in making a bearing component of an artificial joint implant. In the method, the first step is forming a blend containing UHMWPE powder and optionally an antioxidant and/or a crosslinker. Then, first conditions of pressure and heat at a first temperature are applied to consolidate the UHMWPE. Thereafter, second conditions of pressure and heat at a second temperature are applied to activate the crosslinker and crosslink the consolidated UHMWPE. Conveniently, the second temperature is higher than the first temperature, and the crosslinker is activated at the second temperature.

In various embodiments, the antioxidant is a Vitamin E compound or a hindered amine light stabilizer (HALS). The crosslinker is a carbon-carbon initiator that is free of peroxide groups and capable of thermally decomposing into carbon-based free radicals by breaking at least one carbon-carbon single bond. Representative examples include high temperature carbon based initiators represented by the structure:

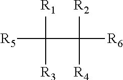

where R₁, R₂, R₃, and R₄, are independently selected from hydrogen and hydrocarbyl, R₅ and R₆ are independently selected from aryl and substituted aryl. In various embodiments, at least two of R₁, R₂, R₃, and R₄ are not hydrogen. In various embodiments, the UHMWPE produced by the method can be further processed to make a bearing component, such by machining or by direct compression molding.

The first conditions of applying heat and pressure (or equivalently pressure and heat) to consolidate the UHMWPE involve subjecting the blend of UHMWPE, optional antioxidant, and optional crosslinker to strain at first temperature T₁ above the melting point. Pressure above ambient conditions is applied for at least a fraction of the time the first conditions are applied. In one embodiment, strain is applied during the first conditions by subjecting the UHMWPE to varying, cyclic, or periodic pressure. In various embodiments, strain is applied at this stage using high temperature melting, extrusion, mechanical deformation, compression molding, or heating in a passive constraint, to give non-limiting examples. The result of the application of strain is a consolidated UHMWPE, optionally containing antioxidant and crosslinker. Advantageously, the antioxidant if present is uniformly dispersed in the solid UHMWPE. Further, if the crosslinker is present, it is activated only at a temperature higher than T₁, and essentially does not crosslink the UHMWPE during application of the strain that result in consolidation under the first conditions. After consolidation, second conditions of pressure and heat at a temperature T₂ greater than T₁ are applied to activate the crosslinker and prepare a crosslinked UHMWPE.

### DESCRIPTION

The following description of technology is merely exemplary in nature of the composition, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Description.

In one embodiment, a method of preparing a crosslinked oxidation resistant UHMWPE for use in making a bearing component of an artificial joint implant involves 1) forming a blend containing UHMWPE powder, optional antioxidant, and crosslinker; 2) applying conditions of pressure and heat at a first temperature to consolidate the UHMWPE; and 3) applying conditions of pressure and heat at a second temperature to activate the crosslinker and crosslink the consolidated UHMWPE. The second temperature at which the crosslinker is activated is higher than the first temperature at which the consolidation is carried out. The crosslinker is activated at the second temperature, and does not significantly activate at the first temperature. In various embodiments, the first temperature is below 210° C. (and above the melting temperature) and the second temperature is above 220° C.

In another embodiment, a method of preparing a crosslinked ultrahigh molecular weight polyethylene for use in making a bearing component of an artificial joint implant, includes the steps of 1) forming a blend comprising UHMWPE powder, a hindered amine light stabilizer, and crosslinker; 2) applying first conditions of pressure and heat at a first temperature to consolidate the blend; and 3) applying second conditions of pressure and heat at a second temperature to activate the crosslinker and crosslink the consolidated blend. The second temperature is higher than the first temperature and the crosslinker is activated at the second temperature.

In various embodiments herein, the crosslinker comprises a compound represented by the structure

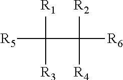

wherein R₁, R₂, R₃, and R₄ are independently selected from hydrogen and hydrocarbyl, R₅ and R₆ are independently selected from aryl and substituted aryl, and at least two of R₁, R₂, R₃, and R₄ are not hydrogen.

In an illustrative example, the first conditions of pressure and heat at the first temperature involve direct compression of the blend to a final shape or near final shape of the bearing component. In other embodiments, the methods further involve machining the bearing component from the crosslinked consolidated UHMWPE product of step 3).

In various embodiments, the blend that is subject to first conditions of pressure and heat contains antioxidant in addition to the UHMWPE powder and crosslinker. In various embodiments, the antioxidant is a Vitamin E compound or a hindered amine antioxidant, both of which are further described herein. In various embodiments, the crosslinker is a carbon based high temperature compound described further herein.

Various aspects of the different parameters referred to in the summary of the methods above can be mixed and matched to provide a method according to the invention. Unless context requires otherwise, it is intended that variations of one component or limitation can be combined with values of all of the other components or limitations to provide methods according to the current teachings. Further non-limiting description of certain of the parameters follows.

### Implants

In various embodiments, bearing components for medical implants are manufactured using preformed polymeric compositions having the structures described herein and made by the methods described herein. Non-limiting examples of implants include hip joints, knee joints, ankle joints, elbow joints, shoulder joints, spine, temporo-mandibular joints, and finger joints. In hip joints, for example, the preformed polymeric composition can be used to make the acetabular cup or the insert or liner of the cup. In the knee joints, the compositions can be made used to make the tibial plateau, the patellar button, and trunnion or other bearing components depending on the design of the joints. In the ankle joint, the compositions can be used to make the talar surface and other bearing components. In the elbow joint, the compositions can be used to make the radio-humeral or ulno-humeral joint and other bearing components. In the shoulder joint, the compositions can be used to make the glenero-humeral articulation and other bearing components. In the spine, intervertebral disc replacements and facet joint replacements can be made from the compositions.

### Forming a Blend Containing UHMWPE Powder, Optional Antioxidant, and Crosslinker

### UHMWPE

UHMWPE is available commercially in powder, flake, or particulate form from a variety of suppliers. It is a standard item in commerce and can be obtained for example from Ticona. As is conventional, the UHMWPE refers to polyethylene prepared using Ziegler-Natta catalysis, and characterized by formal molecular weights of 1 million and higher, for example, 2 million and higher, 3 million and higher, or 4 million and higher. The material has been an industry standard for use in making bearing components for artificial joint components for decades.

### Antioxidant—Vitamin E

The UHMWPE powder can be consolidated by applying first conditions of temperature and pressure, as described further herein. Optionally, the blend that is to be consolidated further contains an antioxidant. A preferred antioxidant for use in the methods is known as a hindered amine or a hindered amine stabilizer (HALS).

Other non-limiting examples of antioxidant compounds include tocopherols such as vitamin E, carotenoids, triazines, and others.

As used here, the term vitamin E is used as a generic descriptor for all tocol and tocotrienol derivatives that exhibit vitamin E activity, or the biological activity of α-tocopherol. Commercially, vitamin E antioxidants are sold as vitamin E, α-tocopherol, and related compounds. The term tocol is the trivial designation for 2-methyl-2-(4,8,12-trimethyltridecyl)chroman-6-ol (compound I, R¹=R²=R³=H).

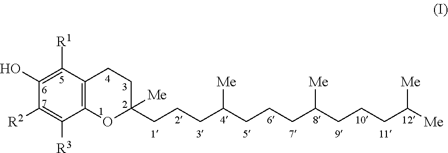

The term tocopherol is used as a generic descriptor for mono, di, and tri substituted tocols. For example, α-tocopherol is compound I where R¹=R²=R³=Me; β-tocopherol is compound I where R¹=R³=Me and R²=H. Similarly, γ-tocopherol and δ-tocopherol have other substitution patterns of methyl groups on the chroman-ol ring.

Tocotrienol is the trivial designation of 2-methyl-2-(4,8,12-trimethyltrideca-3,7,11-trienyl)chroman-6-ol.

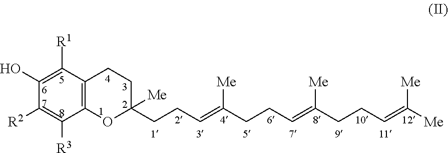

Examples of compound II include 5,7,8-trimethyltocotrienol, 5,8-dimethyltocotrienol, 7,8-dimethyltocotrienol, and 8-methyltocotrienol.

In compound I, there are asymmetric centers at positions 2, 4′, and 8′. According to the synthetic or natural origin of the various tocol derivatives, the asymmetric centers take on R, S, or racemic configurations. Accordingly, a variety of optical isomers and diasteromers are possible based on the above structure. To illustrate, the naturally occurring stereoisomer of α-tocopherol has the configuration 2R,4′R,8′R, leading to a semi-systematic name of (2R,4′R,8′R)-α-tocopherol. The same system can be applied to the other individual stereoisomers of the tocopherols. Further information on vitamin E and its derivatives can be found in book form or on the web published by the International Union of Pure and Applied Chemistry (IUPAC). See for example, 1981 recommendations on “Nomenclature of Tocopherols and Related Compounds.”

### Antioxidant—Carotenoids

Carotenoids are a class of hydrocarbons (carotenes) and their oxygenated derivatives (xanthophylls) consisting of eight isoprenoid units joined in such a manner that the arrangement of isoprenoid units is reversed at the center of the molecule. As a result, the two central methyl groups are in a 1,6-positional relationship and the remaining nonterminal methyl groups are in a 1,5-positional relationship. The carotenoids are formally derived from an acyclic C₄₀H₅₆ structure having a long central chain of conjugated double bonds. The carotenoid structures are derived by hydrogenation, dehydrogenation, cyclization, or oxidation, or any combination of these processes. Specific names are based on the name carotene, which corresponds to the structure and numbering shown in compound III.

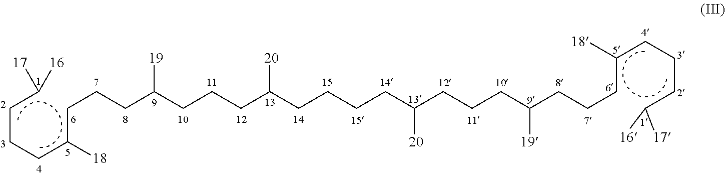

The broken lines at the two terminations represent two “double bond equivalents.” Individual carotene compounds may have C₉ acyclic end groups with two double bonds at positions 1, 2 and 5, 6 (IV) or cyclic groups (such as V, VI, VII, VIII, IX, and X).

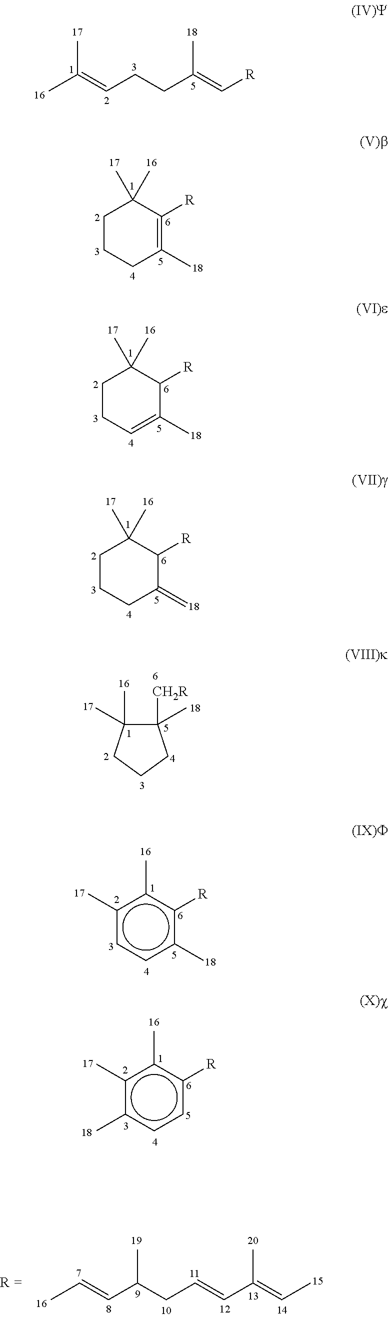

The name of a specific carotenoid hydrocarbon is constructed by adding two Greek letters as prefixes to the stem name carotene. If the end group is acyclic, the prefix is psi (ψ), corresponding to structure IV. If the end group is a cyclohexene, the prefix is beta (β) or epsilon (ε), corresponding to structure V or VI, respectively. If the end group is methylenecyclohexane, the designation is gamma (γ), corresponding to structure VII. If the end group is cyclopentane, the designation is kappa (κ), corresponding to structure VIII. If the end group is aryl, the designation is phi (φ) or chi (χ), corresponding to structures IX and X, respectively. To illustrate, “β-carotene” is a trivial name given to asymmetrical carotenoid having beta groups (structure V) on both ends.

Elimination of a CH₃, CH₂, or CH group from a carotenoid is indicated by the prefix “nor”, while fusion of the bond between two adjacent carbon atoms (other than carbon atoms 1 and 6 of a cyclic end group) with addition of one or more hydrogen atoms at each terminal group thus created is indicated by the prefix “seco”. Furthermore, carotenoid hydrocarbons differing in hydrogenation level are named by use of the prefixes “hydro” and “dehydro” together with locants specifying the carbon atoms at which hydrogen atoms have been added or removed.

Xanthophylls are oxygenated derivatives of carotenoid hydrocarbons. Oxygenated derivatives include without limitation carboxylic acids, esters, aldehydes, ketones, alcohols, esters of carotenoid alcohol, and epoxies. Other compounds can be formally derived from a carotenoid hydrocarbon by the addition of elements of water (H, OH), or of alcohols (H, OR, where R is C₁₋₆ alkyl) to a double bond.

Carotenoids having antioxidant properties are among compounds suitable for the antioxidant compositions of the invention. Non-limiting examples of the invention include vitamin A and beta-carotene, as well as lycopene, lutein, zeaxanthin, echinenone, and zeaxanthin,

### Antioxidant—Hindered Amine Light Stabilizers

In various embodiments, the antioxidant is based on a hindered amine. Many species of this antioxidant are commercially available as so-called hindered amine light stabilizers, generically called HALS. HALS are commercially available from a number of suppliers including DSM, the Cary Company, and BASF. In an aspect, HALS are chemical compounds that activate to produce a nitroxyl (or aminoxyl) radical through a process known as the Denisov cycle. The nitroxyl radical combines with radicals in polymers, such as those induced by reaction of the polymer with oxygen. In one embodiment, HALS are antioxidant molecules that contains hindered amine groups, such as, in non-limiting fashion, a 2,2,6,6-tetramethylpiperidine moiety. Most commercial HALS are derivatives of such a tetramethylpiperidine. Non-limiting examples include those of Formula (XI)

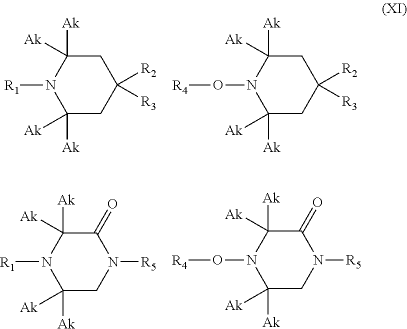

wherein R₁ up to and including R₅ are herein independent substituents; for example containing hydrogen, ether, ester, amine, amide, alkyl, alkenyl, alkynyl, aralkyl, cycloalkyl and/or aryl groups, which substituents may in turn contain functional groups, for example alcohols, ketones, anhydrides, imines, siloxanes, ethers, carboxyl groups, aldehydes, esters, amides, imides, amines, nitriles, ethers, urethanes and any combination thereof. In Formula (XI), the groups Ak are independently hydrocarbyl or substituted hydrocarbyl. In most commercial embodiments, Ak is methyl.

The HALS is preferably used in an amount of between 0.001 and 5% by weight, more preferably between 0.01 and 2% by weight, most preferably between 0.02 and 1% by weight, based on the total weight of the (U)HMWPE.

In various embodiments, the HALS chosen is a compound derived from a substituted piperidine compound, in particular any compound which is derived from an alkyl-substituted piperidyl, piperidinyl or piperazinone compound or a substituted alkoxypiperidinyl compound, including without limitation those of Formula (XI).

Examples of such compounds are: 2,2,6,6-tetramethyl-4-piperidone; 2,2,6,6-tetramethyl-4-piperidinol; bis-(1,2,2,6,6-pentamethylpiperidyl)-(3′,5′-di-tert-butyl-4′-hydroxybenzyl)butylmalonate; di-(2,2,6,6-tetramethyl-4-piperidyl)sebacate (Tinuvin® 770); oligomer of N-(2-hydroxyethyl)-2,2,6,6-tetramethyl-4-piperidinol and succinic acid (Tinuvin® 622); bis-(2,2,6,6-tetramethyl-4-piperidinyl)succinate; bis-(1-octyloxy-2,2,6,6-tetramethyl-4-piperidinyl)sebacate (Tinuvin® 123); bis-(1,2,2,6,6-pentamethyl-4-piperidinyl)sebacate (Tinuvin 765); N,N′-bis-(2,2,6,6-tetramethyl-4-piperidyl)hexane-1,6-diamine (Chimassorb® T5); N-butyl-2,2,6,6-tetramethyl-4-piperidinamine; 2,2′-[(2,2,6,6-tetramethylpiperidinyl)imino]bis-[ethanol]; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346); 5-(2,2,6,6-tetramethyl-4-piperidinyl)-2-cyclo-undecyloxazole) (Hostavin® N20); 8-acetyl-3-dodecyl-7,7,9,9-tetramethyl-1,3,8-triaza-spiro(4,5)decane-2,4-dione; polymethylpropyl-3-oxy-[4-(2,2,6,6-tetramethyl)piperidinyl)siloxane (Uvasil® 299); copolymer of .alpha.-methylstyrene-N-(2,2,6,6-tetramethyl-4-piperidinyl)maleimide and N-stearylmaleimide; 1,2,3,4-butanetetracarboxylic acid, polymer with beta, beta, beta′, beta′-tetramethyl-2,4,8,10-tetraoxaspiro[5.5]undecane-3,9-diethanol, 1,2,2,6,6-pentamethyl-4-piperidinyl ester (Mark® LA63); 2,4,8,10-tetraoxaspiro[5.5]undecane-3,9-diethanol, beta,beta,beta′,beta′-tetramethyl-, polymer with 1,2,3,4-butanetetracarboxylic acid, 2,2,6,6-tetramethyl-4-piperidinyl ester (Mark LA68); D-glucitol, 1,3:2,4-bis-O-(2,2,6,6-tetramethyl-4-piperidinylidene)-(HALS 7); oligomer of 7-oxa-3,20-diazadispiro[5.1.11.2]heneicosan-21-one, 2,2,4,4-tetramethyl-20-(oxiranylmethyl) (Hostavin N30); propanedioic acid, [(4-methoxyphenyl)methylene]-, bis(1,2,2,6,6-pentamethyl-4-piperidinyl) ester (Sanduvor® PR 31); formamide, N,N′-1,6-hexanediylbis[N-(2,2,6,6-tetramethyl-4-piperidinyl (Uvinul® 4050H); 1,3,5-triazine-2,4,6-triamine, N,N′″-[1,2-ethanediylbis[[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorb 119); 1,5-dioxaspiro(5,5)-undecane-3,3-dicarboxylic acid, bis(2,2,6,6-tetramethyl-4-piperidinyl)ester (Cyasorb® UV-500); 1,5-dioxaspiro(5,5)-undecane-3,3-dicarboxylic acid, bis(1,2,2,6,6-pentamethyl-4-piperidinyl) ester (Cyasorb UV-516); N-2,2,6,6-tetramethyl-4-piperidinyl-N-amino-oxamide; 4-acryloyloxy-1,2,2,6,6-pentamethyl-4-piperidine; HALS PB-41 (Clariant Huningue S. A.); 1,3-benzendicarboxamide, N,N′-bis(2,2,6,6-tetramethyl-4-piperidinyl) (Nylostab® S-EED (Clariant Huningue S. A.)); 3-dodecyl-1-(2,2,6,6-tetramethyl-4-piperidyl)-pyrrolidin-2,5-dione; 1,3-Propanediamine, N,N-1,2-ethanediylbis-, polymer with 2,4,6-trichloro-1,3,5-triazine, reaction products with N-butyl-2,2,6,6-tetramethyl-4-piperidinamine (Uvasorb® HA88); 1,1′-(1,2-ethane-diyl)-bis-(3,3′,5,5′-tetramethylpiperazinone) (Good-rite® 3034); 1,1′,1″-(1,3,5-triazine-2,4,6-triyltris((cyclohexylimino)-2,1-ethanediyl)-tris(3,3,5,5-tetramethylpiperazinone); (Good-rite 3150); 1,1′,1″-(1,3,5-triazine-2,4,6-triyltris((cyclohexylimino)-2,1-ethanediyl)-tris(3,3,4,5,5-tetramethylpiperazinone) (Good-rite 3159); 1,2,3,4-Butanetetracarboxylic acid, tetrakis(2,2,6,6-tetramethyl-4-piperidinyl)ester (ADK STAB® LA-57) and 1,2,3,4-butanetetracarboxyllc acid, 1,2,3-tris-(1,2,2,6,6-penta-methyl-4-piperidyl)-4-tridecylester (ADK STABLA-62).

Further non-limiting examples: Mixture of esters of 2,2,6,6-tetramethyl-4-piperidinol and several fatty acid (CYASORB® UV3853); Propanedioic acid, [(4-methoxyphenyl)methylene]-, bis(2,2,6,6-tetramethyl-4-piperidinyl)ester (HOSTAVIN® PR-31); 3-Dodecyl-1-(2,2,6,6-tetramethyl-4-piperidyl)-pyrrolidin-2,5-dione (CYASORB® UV3581); 3-Dodecyl-1-(1,2,2,6,6-pentamethyl-4-piperidyl)-pyrrolidin-2,5-dione (CYAS ORB UV3641); 1,2,3,4-butanetetracarboxylic acid, tetrakis-(1,2,2,6,6-pentamethyl-4-piperidinyl) ester (ADK STAB® LA-52); 1,2,3,4-butanetetracarboxyllc acid, 1,2,3-tris-(2,2,6,6-tetramethyl-4-piperidyl)-4-tridecylester (ADK STABLA-67); Mixture of: 2,2,4,4-tetramethyl-21-oxo-7-oxa-3,20-diazadispiro[5.1.11.2]-heneicosane-20-propionic acid dodecylester and 2,2,4,4-tetramethyl-21-oxo-7-oxa-3,20-diazadispiro[5.1.11.2]-heneicosane-20-propionic acid tetradecylester (Hostavin N24); Poly[[6-[(1,1,3,3-tetramethylbutyl)amino]-s-triazine-2,4-diyl][2,2,6,6-te-tramethyl-4-piperidinylyl)-imino]hexamethylene-[(2,2,6,6-tetramethyl-4-piperidinyl)imino]] (Chimassorb® 944); 1,3,5-Triazine-2,4,6-triamine, N,N′″-[1,2-ethanediylbis[[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis-(1,2,2,6,6-pentamethyl-4-piperidinyl) (Chimassorb 119); Poly[(6-morpholino-s-triazine-2,4-diyl) [1,2,2,6,6-penta-methyl-4-piperidy-1)imino]-hexamethylene[(1,2,2,6,6penta-methyl-4-piperidinyl)imino]] 1,6-Hexanediamine, N,N′-bis(1,2,2,6,6-pentamethyl-4-piperidinyl)-, Polymers with morpholine-2,4,6-trichloro-1,3,5-triazine (CYAS ORB UV3529); Poly-methoxypropyl-3-oxy[4(1,2,2,6,6-pentamethyl)-piperidinyl]-siloxane (Uvasil 816); 1,6-Hexanediamine, N,N′-bis(2,2,6,6-tetramethyl-4-piperidinyl)-, polymer with 2,4,6-trichloro-1,3,5-triazine, reaction products with N-butyl-1-butanamine and N-butyl-2,2,6,6-tetramethyl-4-piperidinamine (Chimassorb 2020); Reaction products of N,N′-(ethane-1,2-diyl)-bis-(1,3-propanediamine), cyclohexane, peroxidized 4-butylamino-2,2,6,6-tetramethylpiperidine and 2,4,6-trichloro-1,3,5-triazine (Flamestab NOR® 116); 1,6-hexanediamine, N,N′-bis(2,2,6,6-tetramethyl-4-piperidinyl)-, polymer with 2,4,6-trichloro-1,3,5-triazine, reaction products with 3-bromo-1-propene, N-butyl-1-butanamine and N-butyl-2,2,6,6-tetramethyl-4-piperidinamine, oxidized, hydrogenated (Tinuvin NOR® 371).

### Phenolic Antioxidants

Phenolic antioxidants, include tocopherols and tocotrienols, which are also further defined and exemplified in the section on vitamin E. Non-limiting examples of tocopherols include dl-alpha-tocopherol, alpha-tocopherol, delta-tocopherol, gamma-tocopherol, and beta-tocopherol. Tocotrienols include, without limitation, alpha-tocotrienol, beta-tocotrienol, gamma-tocotrienol, and delta-tocotrienol.

Other phenolic antioxidants include curcuminoids, such as without limitation curcumin (i.e., diferuloymethane), demethoxycurcumin, bisdemethoxycurcumin, tetrahydrocurcumin, hexahydrocurcumin, curcumin sulphate, curcumin-glucuronide, hexahydrocurcuminol, and cyclocurcumin.

Other phenolic antioxidants include flavonoids such as, without limitation, naringenin, quercetin, hesperitin, luteolin, catechins (such as epigallocatechin gallate, epigallocatechin, epicatechin gallate, and epicatechin), anthocyanins (such as cyanidin, delphinidin, malvidin, peonidin, petunidin, and pelargonidin), phenylpropanoids such as eugenol, and synthetic antioxidants. The latter include those available under tradenames including Irganox® 1010, Irganox® 1076, and Irganox® 245, as well as commercial products like butylated hydroxytoluene (BHT) and butylated hydroxyanisole (BHA).

### Other Antioxidants

In other embodiments, antioxidants are selected from phosphorous compounds, including phosphites and phosphonites, and phosphines. Examples of phosphite include (2,4-di-tert-butylphenyl)phosphite and commercial products Ultranox® U626, Hostanox® PAR24, Irgafos® 168, Irgafos® 126, and Weston® 619. Phosphonites include Sandostab® P-EPQ, and phosphines include PEPFINE®.

Polyhydric alcohol antioxidants include dipentaerythritol, tripentaerythritol, and trimethylolpropane ethoxylate. Benzoquinols include ubiquinol and coenzyme Q10. Other antioxidants include amino-acid-based additives, such as glutathione, cystein, tyrosine, and tryptophan.

Other antioxidants include vitamin C (ascorbic acid) and its derivatives; gallate esters such propyl, octyl, and dodecyl; lactic acid and its esters, tartaric acid and its salts and esters, as well as ortho phosphates. Further non-limiting examples include polymeric antioxidants such as members of the classes of phenols; aromatic amines; and salts and condensation products of amines or amino phenols with aldehydes, ketones, and thio compounds. Non-limiting examples include para-phenylene diamines and diaryl amines.

### Crosslinking Agent

In various embodiments, a blend of UHMWPE powder and antioxidant is consolidated as described herein, with the blend further containing a high temperature crosslinking agent, or crosslinker. Suitable high temperature crosslinking agents are those that react to form carbon radicals at high temperatures. For example, it is possible to choose a chemical compound (such as 2,3-Dimethyl-2,3-diphenylbutane, available commercially under the trade name Perkadox 30) that activates at an elevated temperature, i.e. a temperature above the temperature at which consolidation under the first conditions of heat and pressure is carried out. Non-limiting examples of elevated temperature include a temperature of about 260° C. or higher, 280° C. or higher, or 300° C. and higher, at which the crosslinking agents react to form stabilized carbon radicals. The carbon radicals then interact with the polymer backbone to crosslink the UHMWPE. For example, the high temperature crosslinking agents can be selected from compounds having the general formula:

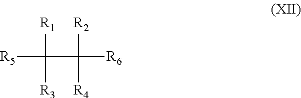

in the formula, the groups R₁ R₂, R₃, and R₄ are independently selected from H and hydrocarbyl, wherein at least two of them are not hydrogen. In various embodiments, R₁-R₄ are independently hydrogen, C₁₋₆ alkyl, C₁₋₃ alkyl, or methyl. The groups R₅ and R₆ are independently aryl, each optionally substituted with chemical groups that do not interfere with action of the compound as a crosslinker. In various embodiments, the groups R₅ and R₆ are aryl substituted with alkyl, aryl, substituted alkyl or substituted aryl.

The carbon based crosslinkers described above are characterized by having relatively high temperatures at which they are activated, in comparison to the lower activation temperatures of organic peroxides. In particular, the crosslinkers activate at a temperature above the temperature at which the consolidation of the blend is carried out. To illustrate, in one embodiment, consolidation is carried out at about 200° C., while activation of the crosslinkers occurs in a subsequent step at a temperature of about 270° C. or higher.

### Consolidating at First Conditions of Pressure and Heat

Throughout the specification, “conditions of heat and pressure” “conditions of temperature and pressure,” “conditions of pressure and heat,” “conditions of pressure and temperature,” and similar phrases are intended to be synonymous.

After the blend containing UHMWPE, optional antioxidant, and crosslinker is formed, it is consolidated at a temperature above the melting temperature and under pressure. For purposes of description, these conditions are referred to as a first set of conditions of pressure and heat, or first conditions of pressure and heat, to distinguish it from the (second) conditions of pressure and heat that will be used later in the process to crosslink the consolidated blend.

In general, the temperature at which the blend is consolidated is selected to be higher than the melting temperature of the UHMWPE. While it is possible to choose the temperature as being above the onset melting temperature of the UHMWPE (i.e. above the temperature at which an endotherm corresponding to the phase the change is first observed), it is more usual to select a temperature above the peak melting temperature of the polymer. The peak melting temperature is also observed in a DSC measurement. Depending on the source and grade of the polymer, the temperature in the first conditions of temperature and pressure (or equivalently of pressure and heat) will be approximately 150° C. or higher. When the blend contains the carbon based crosslinker, it is desirable to maintain the temperature in the first conditions at a temperature lower than that at which the crosslinker is activated.

At the same time that the temperature of the first conditions is held above the melting temperature of the UHMWPE, pressure is applied to consolidate the molten polymer. In a non-limiting example, the resin is made into a fully consolidated stock in a series of cold and hot isostatic pressure treatments such as described in England et al., U.S. Pat. No. 5,688,453 and U.S. Pat. No. 5,466,530, the disclosures of which are hereby incorporated by reference. The fully consolidated stock is suitable for subsequent crosslinking and further treatment as described herein.

Methods of applying pressure during consolidation of UHMWPE powder include application of isostatic pressure by forming the blend into a shape and pressurizing the air or other gas in a pressure vessel to hold the shape while the temperature is applied. Another method of consolidation is to apply the pressure as hydrostatic pressure, wherein a liquid surrounding a formed object is pressurized in a vessel. Another way of applying suitable pressure during the consolidation process is to apply the pressure in a compression mold while the temperature is held above the melting point. Ram extrusion is another method of consolidation. In one embodiment, conventional methods of consolidating the UHMWPE powder with the optional antioxidant and crosslinker are used.

In other embodiments, it is possible to heat the blend in a passive constraint, wherein thermal expansion of the blend material at the temperature of the first conditions of temperature and pressure applies pressure to the blend as an equal and opposite reaction to the expansion.

In one embodiment, use of a passive constraint involves inserting a consolidated polymer such as UHMWPE, in the form of a cylindrical bar of diameter from about 2 inches to about 4 inches, into a rigid sleeve, wherein the sleeve has a diameter greater than that of the UHMWPE bar, and wherein upon insertion, an inner wall of the sleeve contacts some but not all of the UHMWPE bar. It contacts at least some of the inner diameter (i.d.) by gravity alone. Then the UHMWPE is heated in the sleeve to a temperature above the peak melting temperature of the UHMWPE, after which it is cooled and removed from the sleeve. In various embodiments, the UHMWPE is heated in the sleeve to a temperature about 150° C. or higher, about 160° C. or higher, about 170° C. or higher, about 180° C. or higher, about 190° C. or higher, or about 200° C. or higher. The sleeve is dimensioned so that the UHMWPE thermally expands and contacts the entire inner wall of the sleeve during the heating step.

The sleeve that holds the UHMWPE during heating is made of a rigid material that can withstand the temperature and pressure conditions of the treatment. Suitable metal tubes are available, such as those made from aluminum or steel. A standard thin walled pipe with outer diameter (o.d.) of four inches and an inner diameter (i.d.) of about 3.87 inches is suitable. In one embodiment, a sleeve of that dimension is used and a UHMWPE rod of about 3.75 inches diameter is inserted before heating.

Consolidation under the first conditions of temperature and pressure (or equivalently of pressure and heat) leads in various embodiments to a consolidated UHMWPE in a form of a block, a preform suitable for machining into a bearing component, a near finished part, or even a finished part such one prepared by direct compression molding.

### Crosslinking at Second Conditions of Pressure and Heat

Since it contains a crosslinker, the consolidated blend can be made subject to a crosslinking reaction by increasing the temperature to a temperature at which the crosslinker is activated and applying second conditions of temperature and pressure (or equivalently of pressure and heat). If desired, the second conditions can include ambient pressure, because the UHMWPE does not need to be consolidated further.

In various embodiments, the second conditions of heat and pressure are applied in an inert atmosphere such as nitrogen or argon, or in a reduced oxygen environment. A vacuum or partial vacuum can be pulled to reduce the partial pressure of oxygen, by way of non-limiting example. In various embodiments, the second conditions include heating in an atmosphere with oxygen at a partial pressure of 0.2 atm or less, 0.1 atm or less, 0.05 atm or less, 0.01 atm or less, 0.002 atm or less, 0.001 atm or less, down to 10⁻⁴, 10⁻⁵, or 10⁻⁶ atm or less. The partial pressure can be reduced by pulling vacuum, by flushing the chamber with inert gas such as nitrogen or argon, or by a combination.

But the temperature applied during the second conditions is higher than the consolidation temperature applied during the first conditions to consolidate the polymer. Advantageously, the crosslinker is activated at a temperature well above the above-the-melt temperature at which consolidation is carried out. Such high temperatures of activation are not accessible with the use of standard or conventional chemical crosslinkers. In this regard, even so-called high temperature peroxides activate significantly even at the temperature of consolidation.

The high temperature crosslinkers used herein are characterized by a half-life that is a function of temperature. For example, a certain crosslinker having R5 and R6 equal to phenyl and R1, R2, R3, and R4 all equal to methyl is characterized by a half-life of about 8 minutes at 280° C. Respective temperatures of consolidation and crosslinker activation are selected such that at the lower temperature of consolidation, the crosslinker does not activate to such an extent that physical properties are detrimentally affected. Suitable combinations of conditions can be found by empirical observation. As a rule of thumb, the activation half-life of the crosslinker in the solid state at the temperature of consolidation should be significant, for example at least several hours. In various embodiments, the half-life of the crosslinker at the consolidation temperature is 4 hours or longer, 8 hours or longer, 12 hours or longer, 20 hours or longer, at least 1 day, at least 2 days, and so on. To illustrate, the half-life of the certain crosslinker noted above is over 200 days at a typical consolidation temperature of 184° C., but only minutes at an activation temperature of 280° C. And when selecting suitable crosslinkers, it is to be noted that the half-lives could turn out to be even longer when the crosslinkers are activated in a solid state reaction like that of crosslinking UHMWPE than the literature- or supplier-reported half-lives of the crosslinkers from solution measurements would indicate.

In various embodiments, the temperature applied during the second conditions include temperature significantly higher than those applied during consolidation. In various embodiments, the temperature during the second conditions is higher by 10° C., 20° C., 30° C., 40° C., 50° C., 60° C., 70° C., 80° C., 90° C., 100° C. or more than the temperature during the consolidation, which in turn is normally above the melting point (defined as above the onset melting temperature or above the peak melting temperature as determined in a differential scanning calorimetry experiment) of the polymer or above 150° C. in the case of UHMWPE. In various embodiments, the temperature of activation is 230° C. or higher, 250° C. or higher, 260° C. or higher, 270° C. or higher, 280° C. or higher, 290° C. or higher, 300° C. or higher. The temperature of crosslinking is naturally dependent upon the precise nature of the crosslinking compound, and can be 350° C., 400° C., or higher. The crosslinking should also be carried at temperatures below the decomposition temperature of the polymer, or below any temperature at which the crosslinker is no longer effective. In various embodiments, the temperature during consolidation is 150-200° C. and the temperature during activation is 250-320° C.

In a particular embodiment, the crosslinking is carried out on a consolidated blend that contains a HALS as the antioxidant. In various embodiments, it is observed that the HALS antioxidant compounds do not have a deleterious effect on the crosslinking by high temperature carbon based crosslinkers.

### Downstream Processing of the Crosslinked UHMWPE

Where a direct compression molding is used in the first conditions of temperature and pressure to form a consolidated UHMWPE in the shape of a bearing component, no further processing is normally required in order to make a finished part. However, when other forms of UHMWPE are consolidated in the first conditions of temperature and pressure, the usual procedure is to machine a bearing component from the crosslinked UHMWPE made from applying the second conditions of temperature and pressure.

Optionally, the consolidated blend optionally containing antioxidant can be crosslinked, for example, by exposure to gamma irradiation or electron beam irradiation. Such irradiation can be carried either before or after the high temperature crosslinker is activated at the second conditions of temperature and pressure. Instead or in addition, irradiation can also be carried out at low levels (for example, about 2.5 MRad) for the purpose of sterilizing the UHMWPE. Alternatively, irradiation crosslinking can be carried out as a supplement to the chemical crosslinking. For example, supplemental crosslinking can improve the wear resistance of a bearing component made from a consolidated polymer, and/or e-beam can be used to add extra crosslinking (with concomitant increased wear resistance) to the surface region of the polymer.

After crosslinking, whether through irradiation, chemical means, or a combination of both, the UHMWPE can be further treated to eliminate or reduce free radicals generated by the radiation. The heat treatment can be below the melting temperature (annealing) or above the melting temperature (melting).

### Extruding

In another embodiment of a method for processing UHMWPE for subsequent use in an artificial joint bearing component, a consolidated UHMWPE that is subsequently crosslinked is then mechanically deformed to reduce the concentration of free radicals in the UHMWPE generated during the crosslinking. In one embodiment, deforming is carried out by extruding through a reducing die, extruding through an increasing die, or extruding through an isoareal die, as described in U.S. Pat. No. 7,547,405, Schroeder et al., issued Jun. 16, 2009, the entire disclosure of which is incorporated by reference. After crosslinking and deforming, the deformed UHMWPE is cooled with or without maintaining the deformed shape. Following cooling, the UHMWPE is optionally heat treated for a time sufficient to reduce internal stresses or to recover shape if the cooling was done under pressure keeping the deformed state. The crosslinking, deforming, extruding, and the post-cooling heat treatment are carried out below the melting point or above the melting point of the UHMWPE.

### Deformation

In one embodiment, a crosslinked polymer is subjected to a deformation step carried out either below the melting point in a solid state process or above the onset melting temperature in a melt process. An exemplary process involves the steps of: a) providing a crosslinked UHMWPE, prepared either by activating a carbon based activator in situ following consolidation, or by irradiating a consolidated polyethylene at a dose level between about 1 and about 10,000 kGy; b) heating the irradiated polyethylene to a compression deformable temperature; c) mechanically deforming the polyethylene from step b); and d) cooling the polyethylene for subsequent processing to form an artificial joint bearing component. Any of steps a), b), and c) can be carried out at a temperature below the melting point of the polyethylene or at a temperature above the onset melting temperature, such as at a temperature about 135° C. or higher, about 140° C. or higher, or about 150° or higher. In various non-limiting embodiments, the mechanical deformation mode in step c) is selected from channel flow, uniaxial compression, biaxial compression, oscillatory compression, uniaxial tension, biaxial tension, ultra-sonic oscillation, bending, plane stress compression (channel die). Further details are provided in U.S. Pat. No. 8,076,387, Muratoglu et al., issued Dec. 13, 2011, the entire disclosure of which is hereby incorporated by reference. In other embodiments, the mechanical deformation mode is triaxial compression.

In a particular embodiment, mechanical deformation is accomplished by extruding the heat treated polymer of step b), using an increasing die, a decreasing die, or an isoareal die. Extrusion subjects the UHMWPE to a triaxial compression. In various embodiments, the crosslinked material is heated to a compression deformable temperature above the melting point of the polymer (e.g., from the onset melting temperature to about 80° C. higher than the onset melting temperature) or to a compression deformable temperature below the onset melting temperature (e.g., to a temperature between the onset melting temperature and 50° C. below the melting temperature).

In an exemplary embodiment, when the crosslinked bulk material is at a compression deformable temperature, pressure is applied in step c) to the bulk material to induce a dimensional change in a direction orthogonal to the axial direction. The dimensions of the bulk material change in response to the application of pressure, which results in “working” of the crosslinked material with material flow of the heated bulk material. Force (or, equivalently, pressure, which is force divided by area) is applied so that at least one component of the dimension change is orthogonal to the axial direction of the bulk material, with the dimensional change being either positive or negative. To illustrate, for cylindrical rods and other bulk materials that have a constant cross section along the axial direction of the bulk material, compression force is applied in a direction perpendicular to the axial direction in order to decrease a transverse dimension.

Any suitable methods can be used to apply compression force in a direction orthogonal to the axial direction. Non-limiting examples include extrusion through dies and the use of rollers, compression plates, clamps, and equivalent means.

Advantageously, the deformation temperature can be above the melting temperature, which not only results in faster reaction times, but also tends to eliminate free radicals more completely, leading to oxidation resistant materials.

Following the deformation step c), in various embodiments the polyethylene is further processed in a further series of steps to provide a bearing component. These steps involve cooling the deformed polymer with or without maintaining deformation pressure during cooling, subsequently heat treating the cooled polymer to reduce internal stresses and/or to permit recovery of shape from before the deformation, and are then followed by various machining or sterilization steps to make a bearing component for in vivo use. Details of these steps, as well as those of steps a), b), and c) above, are given in U.S. Pat. No. 7,462,318, Schroeder et al., issued Dec. 9, 2008, and U.S. Pat. No. 7,547,405, Schroeder et al., issued Jun. 16, 2009, the full disclosures of which are incorporated by reference.

### Doping

If no antioxidant is included in the consolidated blend, or if it is desired to supply additional antioxidant, doping with antioxidant can occur after consolidation but prior to or after any of the crosslinking, heat treating, deforming or other post processing steps described above.

In various embodiments, the consolidated UHMWPE is subsequently doped with antioxidant, with or without crosslinking. Antioxidant compositions useful herein contain one or more antioxidant compounds. Non-limiting examples of antioxidant compounds include tocopherols such as vitamin E, carotenoids, triazines, vitamin K, and others. Hindered amine light stabilizers are preferred in some embodiments. Preferably, the antioxidant composition comprises at least about 10% of one or more antioxidant compounds. In various embodiments, the antioxidant composition is at least about 50% by weight antioxidant up to and including 100%, or neat antioxidant.

As used here, the term vitamin E is used as a generic descriptor for all tocol and tocotrienol derivatives that exhibit vitamin E activity, or the biological activity of α-tocopherol. Commercially, vitamin E antioxidants are sold as vitamin E, α-tocopherol, and related compounds.

Carotenoids having antioxidant properties are among compounds suitable for the antioxidant compositions of the invention. Non-limiting examples of the invention include vitamin A and beta-carotene.

Other antioxidants include vitamin C (ascorbic acid) and its derivatives; vitamin K; gallate esters such propyl, octyl, and dodecyl; lactic acid and its esters; tartaric acid and its salts and esters; and ortho phosphates. Further non-limiting examples include polymeric antioxidants such as members of the classes of phenols; aromatic amines; and salts and condensation products of amines or amino phenols with aldehydes, ketones, and thio compounds. Non-limiting examples include para-phenylene diamines and diaryl amines.

Antioxidant compositions preferably have at least about 10% by weight of the antioxidant compound or compounds described above. In preferred embodiments, the concentration is about 20% by weight or more or about 50% by weight or more. In various embodiments, the antioxidant compositions are provided dissolved in suitable solvents. Solvents include organic solvents and supercritical solvents such as supercritical carbon dioxide. In other embodiments, the antioxidant compositions contain emulsifiers, especially in an aqueous system. An example is vitamin E (in various forms such as α-tocopherol), water, and suitable surfactants or emulsifiers. In a preferred embodiment, when the antioxidant compound is a liquid, the antioxidant composition consists of the neat compounds, or 100% by weight antioxidant compound.

During the doping process, the bulk material is exposed to antioxidant in a doping step followed by heat treatment or homogenization out of contact with the antioxidant. Total exposure time of the bulk material to the antioxidant is selected to achieve suitable penetration of the antioxidant. In various embodiments, total exposure time is at least several hours and preferably greater than or equal to one day (24 hours).

Additional information about certain aspects of the invention is provided below. It is to be understood that description of individual steps in an overall method of preparing oxidation-resistant polymers for use inter alia as bearing components for artificial joint medical implants can be combined with other steps to provide additional new methods.

### Crosslinkers

Described herein are methods and approaches not found in the field for making cross-linked, wear and oxidation resistant polymers, and materials used therein.

In various aspects the invention relates to aspects use of a new class of crosslinking agents for UHMWPE and implants made therefrom.

The crosslinking agent is a carbon-carbon initiator that is free of peroxide groups and capable of thermally decomposing into carbon-based free radicals by breaking at least one carbon-carbon single bond.

In various non-limiting embodiments, the crosslinking agent is selected from compounds of Formula (XIII):

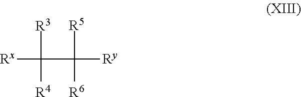

where R³, R⁴, R⁵, R⁶, R^{x} and R^{y} are independently selected from hydrogen, hydrocarbyl, and substituted hydrocarbyl. In various embodiments, R^{x} and R^{y} are independently selected from substituted or unsubstituted aromatic hydrocarbyl. Hydrocarbyl groups can be substituted or unsubstituted, and can be radicals of straight, branched, cyclic, or aromatic hydrocarbons, as desired. Advantageously, both R^{x} and R^{y} are independently selected from substituted or unsubstituted aryl, for example substituted or unsubstituted phenyl. In various embodiments, R³, R⁴, R⁵ and R⁶ are independently selected from alkyl groups. Examples of alkyl include C₁₋₆ alkyl, C₁₋₃ alkyl, methyl, and ethyl.

More particularly, the crosslinking agent is selected from compounds of Formula XIV:

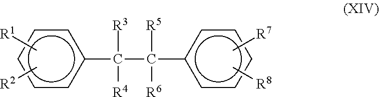

wherein R¹, R², R⁷, and R⁸ are independently selected from hydrogen, C₁₋₆ branched or straight chain alkyl, C₁₋₆ straight or branched chain alkoxy, nitrile, and halogen, such as fluorine, chlorine, bromine, or iodide, and wherein R³, R⁴, R⁵, R⁶ are independently selected from hydrogen, C₁₋₆ alkyl, and C₁₋₆ alkoxy.

Examples of suitable compounds include: 2,3-dimethyl-2,3-diphenylbutane; 2,3-dipropyl-2,3-diphenylbutane; 2,3-dibutyl-2,3-diphenylbutane; 2,3-dihexyl-2,3-diphenylbutane; 2-methyl-3-ethyl-2,3-diphenylbutane; 2-methyl-2,3-diphenylbutane; 2,3-diphenylbutane; 2,3-dimethyl-2,3-di-(p-methoxyphenyl)-butane; 2,3-dimethyl-2,3-di-(p-methylphenyl)-butane; 2,3-dimethyl-2-methylphenyl-3-(p-2′,3′-dimethyl-3′-methylphenylbutyl)-phenylbutane; 3,4-dimethyl-3,4-diphenylhexane; 3,4-diethyl-3,4-diphenylhexane; 3,4-dipropyl-3,4-diphenylhexane; 4,5-dipropyl-4,5-diphenyloctane; 2,3-diisobutyl-2,3-diphenylbutane; 3,4-diisobutyl-3,4-diphenylhexane; 2,3-dimethyl-2,3-di-p-(t-butyl)-phenylbutane; 5,6-dimethyl-5,6-diphenyldecane; 6,7-dimethyl-6,7-diphenyldodecane; 7,8-dimethyl-7,8-di(methoxyphenyl)-tetradecane; 2,3-diethyl-2,3-diphenylbutane; 2,3-dimethyl-2,3-di(p-chlorophenyl)butane; 2,3-dimethyl-2,3-di(p-iodophenyl)butane; 2,3-dimethyl-2,3-di(p-nitrophenyl)butane; and the like.

In various embodiments, the crosslinker comprises 2,3-dimethyl-2,3-diphenylbutane or 3,4-dimethyl-3,4-diphenylhexane.

The crosslinkers are described by the terms carbon-carbon crosslinkers, carbon-carbon radical crosslinkers, carbon radical source crosslinkers, or similar language. The new crosslinkers can be used with or without addition of antioxidants. Without antioxidants, the carbon-carbon crosslinkers permit and enable sequential consolidation and chemical crosslinking of a polyethylene, especially UHMWPE for production of bearing materials of medical implants. In various embodiments, the methods avoid having to dope the consolidated polymer with antioxidants and/or do away with crosslinking by gamma or e-beam irradiation.

### Use of Antioxidants

When antioxidants are used, aspects of the invention include methods of chemically cross-linking antioxidant-stabilized polymeric material; in some embodiments the crosslinking is limited to the surface. It also provides methods to obtain a wear-resistant polymeric material to be used as a medical implant preform or medical implant using these methods. Crosslinking of polymeric materials can be used to improve wear resistance and the addition of antioxidant can be used to improve oxidation resistance; such materials can be used in orthopedic applications such as bearing surfaces in total or partial joint implants, including total hips, total knees, total shoulders, and other total or partial joint replacements. While radiation cross-linking of polymeric materials can also be used for the same purpose along with antioxidant stabilization, carbon-carbon cross-linking and antioxidant stabilization offers a more affordable fabrication.

One challenge with cross-linking of polymeric materials is how to avoid an ensuing loss of thermal oxidative stability. Antioxidants can be used to prevent this loss of stability in crosslinked polymeric materials and especially in polymeric materials crosslinked using carbon radical source crosslinkers described herein. Another challenge is that, just as it is with radiation crosslinking in the presence of antioxidants, in the presence of antioxidants the efficiency of chemical crosslinking can be reduced. Therefore, a delicate balance between the amounts of carbon-carbon crosslinkers and antioxidant(s) present in the polymeric material needs to be achieved to ensure that enough crosslinking is achieved for wear reduction and that enough antioxidant is incorporated for improved long-term oxidative stability. Suitable high concentrations of antioxidant added to polymeric material along with an optimized amount of crosslinking agent can be used to achieve sufficient crosslinking and oxidative stability.

In one aspect, the invention provides a method of making an oxidation resistant, cross-linked polymeric material. The method includes the steps of:
(a) blending a polymeric material with an antioxidant and a carbon-carbon crosslinking agent;
(b) consolidating the polymeric material thereby forming a consolidated, antioxidant and crosslinking agent-blended polymeric material; and
(c) raising the temperature T to effect chemical crosslinks by the carbon-carbon crosslinkers, optionally in the presence of the antioxidant.

The consolidation step (b) can comprise compression molding, direct compression molding, ram extrusion, or applying isostatic or hydrostatic pressure, as discussed herein. Subsequent heating in step c) can take place at a temperature T above 200° C., above 250° C., above 300° C., or above 350° C.

The method can further include the step of machining the crosslinked polymeric material into a medical implant and/or the step of packaging and sterilizing the medical implant. The sterilizing can be done by gas sterilization or ionizing irradiation, where the latter can be carried out in an inert gas.

The method can further include the step of consolidating a second polymeric material optionally including a second antioxidant as a second layer with a first layer of the polymeric material thereby forming a consolidated, optional antioxidant and crosslinking agent-blended polymeric material. In various embodiments, the composition formed from consolidation is bearing component of a medical implant formed for example by direct compression molding.

In the method, the polymeric material can be selected from ultrahigh molecular weight polyethylenes, high density polyethylene, low density polyethylene, linear low density polyethylene, and mixtures and blends thereof. The polymeric material can be blended with multiple antioxidants and/or multiple cross-linking agents.

In various embodiments, the antioxidant is selected from the hindered amine light stabilizers or from glutathione, lipoic acid, vitamins such as ascorbic acid (vitamin C), vitamin B, vitamin D, vitamin E, tocopherols (synthetic or natural, alpha-, gamma-, delta-), acetate vitamin esters, water soluble tocopherol derivatives, tocotrienols, water soluble tocotrienol derivatives; melatonin, carotenoids including various carotenes, lutein, pycnogenol, glycosides, trehalose, polyphenols and flavonoids, quercetin, lycopene, lutein, selenium, nitric oxide, curcuminoids, 2-hydroxytetronic acid; cannabinoids, synthetic antioxidants such as tertiary butyl hydroquinone, 6-amino-3-pyrodinoles, butylated hydroxyanisole, butylated hydroxytoluene, ethoxyquin, tannins, propyl gallate, other gallates, Aquanox® family; Irganox® and Irganox® B families including Irganox® 1010, Irganox® 1076, Irganox® 1330, Irganox® 1035; Irgafos® family; phenolic compounds with different chain lengths, and different number of OH groups; enzymes with antioxidant properties such as superoxide dismutase, herbal or plant extracts with antioxidant properties such as St. John's Wort, green tea extract, grape seed extract, rosemary, oregano extract, and mixtures, derivatives, analogues or conjugated forms of these.

In various embodiments, methods involve blending polymeric material with antioxidant such that the antioxidant is present in the polymeric material at a concentration of from 0.001 to 50 wt % by weight of the polymeric material, from 0.1 to 2 wt % by weight of the polymeric material, from 0.5 to 1 wt % by weight of the polymeric material, or from 0.6 to 1 wt % by weight of the polymeric material.

In various embodiments, the crosslinking agent is present in the polymeric material at a concentration of from 0.01 to 50 wt % by weight of the polymeric material, from 0.01 to 50 wt % by weight of the polymeric material, from 0.5 to 5 wt % by weight of the polymeric material, or from 0.5 to 2 wt % by weight of the polymeric material.

The method can further include the step of compression molding or direct compression molding the polymeric material to a second surface, thereby making an interlocked hybrid material. The second surface can be porous. The second surface can be a porous metal. The method can further include the step of machining the polymeric material before or after heating.

In another aspect, the invention provides a method of making a crosslinked polymeric material having two different polymeric materials. The method involves consolidating a first polymeric material and a second polymeric material together thereby forming a consolidated polymeric material, wherein at least one of the consolidated first and second polymeric material contains a carbon-carbon crosslinker and the two materials each optionally contain antioxidant. Consolidation is carried out with any suitable method at a temperature where the crosslinker is not significantly activated. After consolidation, the temperature is raised and the polymeric material is crosslinked. The consolidated material can be in the form a net shape or near net shape bearing material or implant, or can be a preform.

In another aspect, the invention provides a method of making an oxidation resistant, crosslinked polymeric material. The method includes the steps of: (a) blending a first polymeric material with a first antioxidant and a first crosslinking agent; (b) blending a second polymeric material with a second antioxidant and optionally a second crosslinking agent; and (c) consolidating the first polymeric material and the second polymeric material together, thereby forming a consolidated, antioxidant and crosslinking agent-blended polymeric material having a first region of the first polymeric material and having a second region of the second polymeric material, thereby forming a consolidated antioxidant and crosslinking agent-blended polymeric material. The first polymeric material and the second polymeric material can be the same or different, and the first antioxidant and the second antioxidant can be the same or different, and the first crosslinking agent and the second crosslinking agent can be the same or different, and levels of crosslinking can be different in the first layer and the second layer. At least one of the first and second polymeric material contains a carbon-carbon crosslinker. In the method, the consolidated antioxidant and crosslinking agent-blended polymeric material is further heated to activate the carbon-carbon crosslinker.

In the methods described herein, the crosslinking agent is a compound that initiates a chemical processes that leads to crosslinking of the polymeric material, where the compound itself does not necessarily attach chemically or ionically to the polymer. For instance, the crosslinking agent can generate a free radical (really a pair of free radicals) that can abstract a hydrogen from the polymeric material, creating a free radical on the polymeric material; subsequently such free radicals on the polymeric material can react with each other to form a crosslink without chemically attaching the cross-linking agent to the polymeric material. The crosslinking agent may also form covalent or ionic bonding with one or more sites on the polymeric material, thereby causing grafting or crosslinking. In this case, the crosslinking agent becomes part of the crosslinked polymeric material. In some embodiments, there are unreacted crosslinking agent and/or the byproducts of the crosslinking agent in the polymeric material that has been chemically crosslinked using the process described herein.

In some embodiments, the unreacted crosslinking agent and/or the byproducts of the crosslinking agent are partially or fully extracted from the polymeric material after crosslinking. This extraction, among other methods, can include solvent extraction, emulsified solvent extraction, heat extraction, supercritical fluid extraction, and/or vacuum extraction. For instance, in some embodiments supercritical carbon dioxide extraction is used. In other embodiments, extraction is accomplished by placing the polymeric material under vacuum with or without heat.

Antioxidants are additives that protect the host polymer against oxidation under various aggressive environments, such as during high temperature consolidation, high temperature crosslinking, low temperature crosslinking, irradiation, and the like. Some antioxidants act as free radical scavengers in polymeric material during crosslinking. Some antioxidants also act as anti-crosslinking agents in polymeric material during crosslinking; these antioxidants scavenge the free radicals generated on polymeric material during cross-linking, thereby inhibiting or reducing the crosslinking efficiency of the polymeric material. Antioxidants/free radical scavengers/anti-crosslinking agents can be chosen from but not limited to glutathione, lipoic acid, vitamins such as ascorbic acid (vitamin C), vitamin B, vitamin D, vitamin-E, tocopherols (synthetic or natural, alpha-, gamma-, delta-), acetate vitamin esters, water soluble tocopherol derivatives, tocotrienols, water soluble tocotrienol derivatives; melatonin, carotenoids including various carotenes, lutein, pycnogenol, glycosides, trehalose, polyphenols and flavonoids, quercetin, lycopene, lutein, selenium, nitric oxide, curcuminoids, 2-hydroxytetronic acid; cannabinoids, synthetic antioxidants such as tertiary butyl hydroquinone, 6-amino-3-pyrodinoles, butylated hydroxyanisole, butylated hydroxytoluene, ethoxyquin, tannins, propyl gallate, other gallates, Aquanox® family; Irganox® and Irganox® B families including Irganox® 1010, Irganox® 1076, Irganox® 1330, Irganox® 1035; Irgafos® family; phenolic compounds with different chain lengths, and different number of OH groups; enzymes with antioxidant properties such as superoxide dismutase, herbal or plant extracts with antioxidant properties such as St. John's Wort, green tea extract, grape seed extract, rosemary, oregano extract, and mixtures, derivatives, analogues or conjugated forms of these. They can be primary antioxidants with reactive OH or NH groups such as hindered phenols or secondary aromatic amines; they can be secondary antioxidants such as organophosphorus compounds or thiosynergists; they can be multifunctional antioxidants; hydroxylamines; or carbon centered radical scavengers such as lactones or acrylated bis-phenols. The antioxidants can be selected individually or used in any combination. Also, antioxidants can be used with in conjunction with other additives such as hydroperoxide decomposers.

Irganox®, as described herein, refers to a family of antioxidants manufactured by Ciba Specialty Chemicals. Different antioxidants are given numbers following the Irganox® name, such as Irganox® 1010, Irganox® 1035, Irganox® 1076, Irganox® 1098, etc. Irgafos® refers to a family of processing stabilizers manufactured by Ciba Specialty Chemicals. The Irganox® family has been expanded to include blends of different antioxidants with each other and with stabilizers from different families such as the Irgafos® family. These have been given different initials after the Irganox® name, for instance, the Irganox® HP family are synergistic combinations of phenolic antioxidants, secondary phosphate stabilizers and the lactone Irganox® HP-136. Similarly, there are Irganox® B (blends), Irganox® L (aminic), Irganox® E (with vitamin E), Irganox® ML, Irganox® MD families. Herein we discuss these antioxidants and stabilizers by their tradenames, but other chemicals with equivalent chemical structure and activity can be used. In addition, these chemicals can be used individually or in mixtures of any composition. Some of the chemical structures and chemical names of the antioxidants in the Irganox® family are listed in Table 1 below.

TABLE 1
Chemical names and structures of some antioxidants trademarked under the Irganox ® name.

| Tradename | Chemical name | Chemical Structure |
|---|---|---|
| Irganox ® 1010 | Tetrakis[methylene (3,5-di-tert- butylhydroxy- hydrocinnamate)] methane | 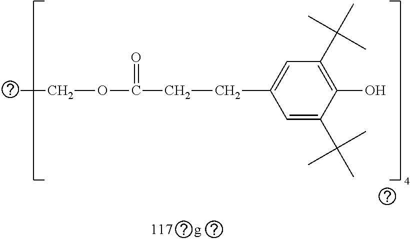 |
| Irganox ® 1035 | Thiodiethylene bis[3-[3,5-di-tert- butyl-4-hydroxy- phenyl]propionate] | 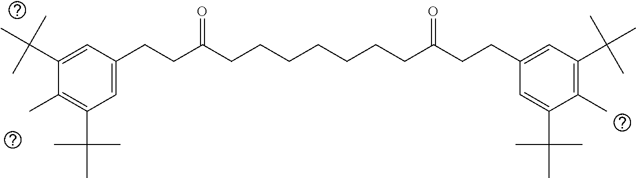 [SMILES: Cc1c(C(C)(C)C)cc(CCC(=O)CCCCCCCC(=O)CCc2cc(C(C)(C)C)c(C)c(C(C)(C)C)c2)cc1C(C)(C)C] |
| Irganox ® 1076 Irganox ® 1098 | Octadecyl 3,5- di-tert-butyl-4- hydroxylhydro- cinnamate N,N′-hexane-1,6- diylbis(3-(3,5-di tert-butyl-4- hydroxyphenyl- propionamide)) | 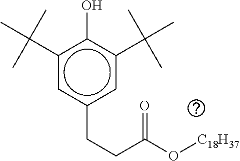 |
| Irganox ® 1135 | Benzenepropanoic acid, 3,5-bis (1,1-dimethyl-ethyl)- 4-hydroxy-C₇-C₉ branched alkyl esters | 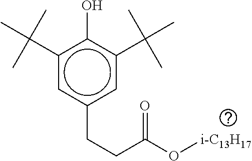 |
| Irganox ® 1330 | 1,3,5-tris(3,5- di-tert-butyl-4- hydroxybenzyl)-2,4,6- trimethylbenzene | 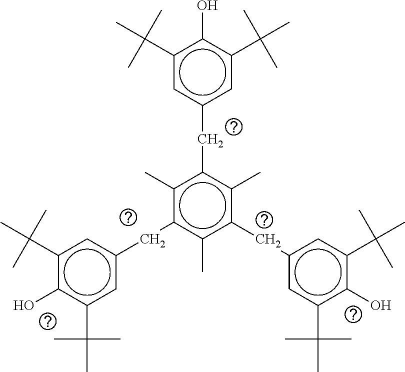 |
| Irganox ® 1520 | | 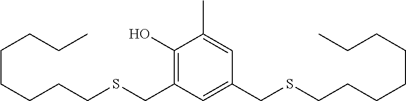 [SMILES: CCCCCCCCSCc1cc(C)c(O)c(CSCCCCCCCC)c1] |
| Irganox ® 1726 | 2,4-bis(dodecyl- thiomethyl)-6- methylphenol | 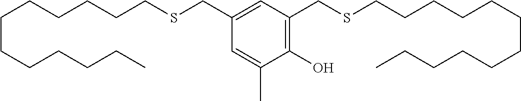 [SMILES: CCCCCCCCCCCCSCc1cc(C)c(O)c(CSCCCCCCCCCCCC)c1] |
| Irganox ® 245 | Triethylene glycol bis(3-tert-butyl-4- hydroxy-5-methyl- phenyl)propionate | 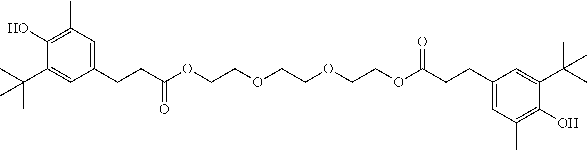 [SMILES: Cc1cc(CCC(=O)OCCOCCOCCOC(=O)CCc2cc(C)c(O)c(C(C)(C)C)c2)cc(C(C)(C)C)c1O] |
| Irganox ® 3052 | 2,2′-methylenebis (4-methyl-6-tert- butylphenol) monoacrylate | 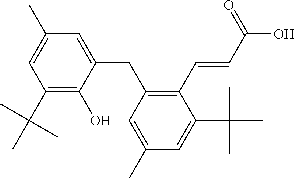 [SMILES: Cc1cc(Cc2cc(C)cc(C(C)(C)C)c2/C=C/C(=O)O)c(O)c(C(C)(C)C)c1] |
| Irganox ® 3114 | 1,3,5-TRis(3,5- di-tert-butyl-4- hydroxybenzyl)- 1,3,5-triazine- 2,4,6(1H,3H, 5H)-trione | 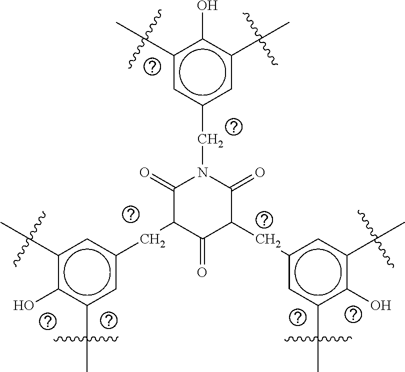 |
| Irganox ® 5057 | Benzenamine, N-phenyl-, reaction products with 2,4,4- trimethylpentene | 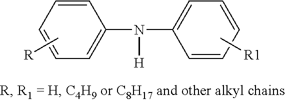 |
| Irganox ® 565 | 2,4-bis(octylthio)- 6-(4-hydroxy-3,5- di-tert-butylanilino)- 1,3,5-triazine | 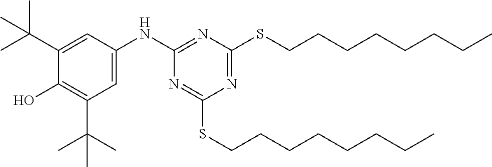 [SMILES: CCCCCCCCSc1nc(Nc2cc(C(C)(C)C)c(O)c(C(C)(C)C)c2)nc(SCCCCCCCC)n1] |
| Irganox ® HP-136 | 5,7-di-t-butyl-3- (3,4 di- methylphenyl)- 3H-benzofuran-2-one | 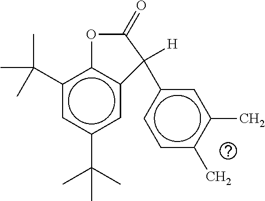 |
| Irgafos ® 168 | Tris(2,4-di-tert- butylphenyl)phospite | 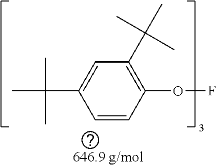 |

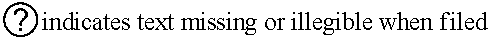

### Polymeric Materials

“Polymeric materials” or “polymer” generally refers to a macromolecule composed of chemically bonded repeating structural subunits. It includes chemical species such as polyolefin that can be crosslinked by reaction with the radicals formed when the consolidated polymer is heated at a temperature to activate the carbon-carbon crosslinkers. Polymeric materials include polyolefins such as polyethylene and polypropylene, for example, high density polyethylene, low density polyethylene, and ultrahigh molecular weight polyethylene (UHMWPE). Ultra-high molecular weight polyethylene (UHMWPE) refers to linear substantially non-branched chains of ethylene having molecular weights in excess of about 500,000, preferably above about 1,000,000, and more preferably above about 2,000,000. Often the molecular weights can reach about 8,000,000 or more. By initial average molecular weight is meant the average molecular weight of the UHMWPE starting material, prior to any irradiation. Superhigh molecular weight polyethylene is a name given to polyethylene that is prepared with Ziegler Natta catalysts to a molecular weight of about 500,000.

For bearing components of medical implants for artificial joints, a preferred material is UHMWPE. One example UHMWPE is GUR® ultra-high molecular weight polyethylene available from Ticona. GUR® ultrahigh molecular weight polyethylene can be processed by compression molding. Non-limiting examples of UHMWPE are GUR 1050™ and GUR 1020™ available from Ticona.

“Polymeric material” or “polymer” can be in the form of resin, flakes, powder, consolidated stock, implant, and can contain additives such as antioxidant(s).

### Consolidation

Consolidation refers generally to processes used to convert the polymeric material resin, particles, flakes, i.e., small pieces of polymeric material, into a mechanically integral large-scale solid form, which can be further processed if desired, for example by machining, in obtaining articles of use such as preforms, or medical implants. Consolidation is carried out in various embodiments by subjecting the polymeric material in particle form to so-called first conditions of temperature and pressure (or equivalently to first conditions of heat and pressure). Consolidation methods such as injection molding, extrusion, direct compression molding, compression molding, (cold and/or hot) isostatic pressing, etc. can be used.

In the case of UHMWPE, consolidation is often performed using “compression molding”. In some instances, consolidation can be interchangeably used with compression molding. The molding process generally involves: (i) heating the polymeric material to be molded, (ii) pressurizing the polymeric material while heated, (iii) keeping at elevated temperature and pressure, and (iv) cooling down and releasing pressure. Typically the consolidation is carried out by pressurizing the heated polymeric material inside a mold to obtain the shape of the mold with the consolidation of the polymeric material. The temperature, pressure, and time during the molding steps make up what are called the first conditions of temperature and pressure (or of heat and pressure) used to consolidate the polymeric material containing the carbon-carbon crosslinkers.

Compression molding can be used to create net shape bearings or near net shape bearings in a process known as direct compression molding. Alternatively, compression molding makes a block or preform that is subsequently machined or otherwise formed into a finished part.

In some embodiments, some of the additives or polymeric materials may generate volatile substances during consolidation. In such instances the volatile substances may need to be removed from the mold during consolidation.

Heating and/or pressurizing of the polymeric material during consolidation at the “first conditions of heat and pressure” can be done at any rate. Temperature and/or pressure can be increased linearly with time or in a step-wise fashion or at any other rate. Alternatively, the polymeric material can be placed in a pre-heated environment. The mold for the consolidation can be heated together or separately from the polymeric material to be molded. Steps (i) and (ii), i.e., heating and pressurizing before consolidation can be done in multiple steps and in any order. For example, polymeric material can be pressurized at room temperature to a set pressure level 1, after which it can be heated and pressurized to another pressure level 2, which still may be different from the pressure or pressure(s) in step (iii). Step (iii), where a high temperature and pressure are maintained is the “dwell period” where a major part of the consolidation takes place. One temperature and pressure or several temperatures and pressures can be used during this time without releasing pressure at any point. For UHMWPE, dwell temperatures at or above the melting temperature, such as in the range of 135° C. to 240° C. can be used. As noted, the maximum temperature for the consolidation will be dependent on the nature of the crosslinker to be activated in a subsequent step under the second conditions. The transition is not necessarily sharp, but generally the carbon carbon crosslinkers tend not to react significantly at about 220° C., and begin to react significantly fast at temperatures above about 240° C. Suitable temperatures for the first and the second conditions are selected with these principles in mind.

Pressures in the range of 0.1 MPa to 100 MPa or up to 1000 MPa can be used. The dwell temperature can be from −20 to 400° C., or can be 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 230° C., 240° C., 250° C., 260° C., 270° C., 280° C., 290° C., 300° C., 320° C. or 340° C., with the proviso that above 240° C. or so care needs to be taken that the crosslinker does not significantly activate. The dwell time can be from 1 minute to 24 hours, more preferably from 2 minutes to 1 hour, most preferably about 10 minutes. For example, dwell time can be 2 hours. Dwell time can be 5, 10, 15, 20, 25, 30, 35, 40, 45, 50, 55, 60 minutes, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9 hours or more. The temperature(s) at step (iii) are part of the first conditions of heat and pressure, and are termed “dwell” or “molding” temperature(s). The pressure(s) used in step (iii) are termed “dwell” or “molding” pressure(s) and likewise are part of the first conditions. In some embodiments, the pressure may increase during the dwell period from the set pressure of the consolidation equipment up to 40 MPa or more. The order of cooling and pressure release step (iv) can be used interchangeably. In some embodiments, the cooling and pressure release may follow varying rates independent of each other. In some embodiments, consolidation of polymeric resin or blends of the resin with crosslinking agent(s) and/or antioxidant(s) are achieved by compression molding.

One way of consolidating UHMWPE is compression molding at a temperature between 180° C. and 210° C. in a mold of desired shape in between heated surfaces by bringing the polymeric material resin to dwell or molding temperature (T_{dwell}), pressurizing the polymeric material resin at temperature and maintaining the temperature and pressure (P_{dwell}) for a desired amount of time (t_{dwell}) to effect consolidation of the polymeric material by inter-diffusion of the polymer chains from neighboring resins into each other. The polymeric material resin is cooled under pressure to yield a consolidated polymeric material. In non-limiting examples, T_{dwell} is between 180° C. and 210° C., t_{dwell} is between 15 minutes and 1 hour, and P_{dwell} is between 10 and 20 MPa. P_{dwell} can be a value between 1 MPa and 100 MPa in 0.5 MPa intervals. In addition, the cooling rate under pressure can contribute to changes in the crystallinity. The cooling rate can be between 0.01° C./min to 200° C./min, preferably 0.5 to 5° C./min, most preferably about 2° C./min. These descriptions also hold true for other polymeric materials where the consolidation temperature is commonly above the glass transition or melting temperature of the polymeric material allowing it to be shaped easily.

In some embodiments, the consolidated polymeric material is fabricated through “direct compression molding” (DCM), which is compression molding using parallel plates or any plate/mold geometry which can directly result in an implant or implant preform. Preforms are generally oversized versions of implants, where some machining of the preform can give the final implant shape.

Compression molding can also be done such that the polymeric material is directly compression molded onto a second surface, for example, a metal or a porous metal to result in an implant or implant preform. This type of molding results in a “hybrid interlocked polymeric material” or “hybrid interlocked material” or “hybrid interlocked medical implant preform” or “hybrid interlocked medical implant” or “monoblock implant”.

### Layered Molding

Compression molding can also be done by “layered molding”. This refers to consolidating a polymeric material by compression molding one or more of its resin forms, which may be in the form of flakes, powder, pellets or the like or consolidated forms in layers such that there are distinct regions in the consolidated form containing different concentrations of additives such as antioxidant(s) or crosslinking agent(s). In various embodiments, it is fabricated by: (a) layered molding of polymeric resin powder or its antioxidant/crosslinking agent blends where one or more layers contain no crosslinking agent(s) and one or more layers contain one or more additives, antioxidants and/or crosslinking agents; (b) molding together of previously molded layers of polymeric material containing different or identical concentration of additives such as antioxidant(s) and crosslinking agent(s) where one or more layers contain no crosslinking agent(s) and one or more layers contain one or more additives, antioxidants and/or anti-crosslinking agents; or (c) molding of UHMWPE resin powder with or without antioxidant(s) and/or crosslinking agent(s) onto at least one previously molded polymeric material with or without antioxidant(s) and/or crosslinking agent(s) where one or more layers contain no crosslinking agent(s) and one or more layers contain one or more additives, antioxidant(s) and/or crosslinking agent(s).

In layered molding, the layer or layers to be molded can be heated in liquid(s), in water, in air, in inert gas, in supercritical fluid(s) or in any environment containing a mixture of gases, liquids or supercritical fluids before pressurization. The layer or layers can be pressurized individually at room temperature or at an elevated temperature below the melting point or above the melting point before being molded together. The temperature at which the layer or layers are pre-heated can be the same or different from the molding or dwell temperature(s). The temperature can be gradually increased from pre-heat to mold temperature with or without pressure. The pressure to which the layers are exposed before molding can be gradually increased or increased and maintained at the same level.

During molding, different regions of the mold can be heated to different temperatures. The temperature and pressure can be maintained during molding for 1 second up to 1000 hours or longer. During cool-down under pressure, the pressure can be maintained at the molding pressure or increased or decreased. The cooling rate can be 0.0001° C./minute to 120° C./minute or higher. The cooling rate can be different for different regions of the mold. After cooling down to about room temperature, the mold can be kept under pressure for 1 second to 1000 hours. Or the pressure can be released partially or completely at an elevated temperature.

Blending of Antioxidant(s) and Cross-Linking Agent(s) into Polymeric Materials for Cross-Linking

In some embodiments of the invention, one or more antioxidants are used to prevent oxidation in the polymeric materials during manufacturing and in vivo use as medical implants. Such manufacturing methods may include high temperature and pressure such as those commonly used in the consolidation and processing of polymeric materials such as injection molding, compression molding, direct compression molding, screw extrusion, or ram extrusion. In some embodiments of the invention, methods of making medical implant preforms and medical implants are described. Such methods may include machining, packaging and sterilization by radiation and/or gas sterilization methods. Any or all of these methods may initiate oxidation in polymeric materials.

In various embodiments of this invention, polymeric material is blended with one or more antioxidants and one or more crosslinking agents. The blend is consolidated into an implant preform. The implant preform is machined to obtain a final implant. The final implant is packaged and sterilized by irradiation or gas sterilization. In some embodiments, one of the antioxidants blended with the polymeric material can be vitamin E.

In some embodiments, the antioxidant blended into the polymeric material is α-tocopherol. In some embodiments, the concentration of the antioxidant in the antioxidant-blended polymeric material is 0 wt %, 0.2 wt %, or 1 wt %. In some embodiments, the concentration of the crosslinker in the polymeric material is 0.05 wt % or 0.1 wt %, or 0.2 wt %, or 0.3 wt %, or 0.4 wt %, or 0.5 wt %, or 0.75 wt %, or 1 wt %, or 2 wt %, or 5 wt % or more.

### Blending Process

If the cross-linking agent(s) and/or antioxidant(s) to be blended with the polymeric material are solid, then they can be dry mixed with the polymer resin manually or by using a mixer. If the polymeric material is not a powder, it can be made into powder by using a pulverizer. Alternatively, if any component is liquid, it can be mixed in pure form directly into the polymeric material. Alternatively the additive can be dissolved in a solvent to form an additive solution. The additive solution can then be mixed with the polymeric material and the solvent can be evaporated thereafter.

In any of the embodiments of this invention, where the cross-linking agent(s) and/or antioxidant(s) are blended with the polymeric material, solvent(s) can be used to aid the dispersion of the components in the subsequently consolidated blend. Any solvent, in which one or more of the components are soluble or dispersed, can be used. In some embodiments, it is preferred that the cross-linking agent(s) and/or antioxidant(s) be soluble in isopropanol, ethanol, or acetone. Different solvents can be used to blend different components simultaneously or in any sequence. After the blending, it is preferred that the solvent(s) are evaporated before consolidation of the blend. In any of the embodiments, components can be mixed with each other simultaneously or in any sequence.

### Irradiation

Exposure to irradiation is known to crosslink most polymeric materials. Radiation crosslinking of UHMWPE is used in reducing the wear rate of UHMWPE used in joint replacements. In various embodiments, a method involves irradiating a consolidated polymeric material either before or after applying the second conditions of temperature and pressure to activate (chemical) crosslinking. The method can include the step of irradiating the consolidated polymeric material at a radiation dose between about 25 kGy and about 1000 kGy. The consolidated polymeric material can be irradiated at a temperature between about 20° C. and about 135° C. or at a temperature about 135° C. or above. Irradiation can be done in air, or in vacuum, or in an inert atmosphere such as N₂, Ar, and the like.

In some embodiments, a consolidated UHMWPE containing crosslinking agent and optionally an antioxidant is exposed to radiation either 1) before the crosslinker is activated, or 2) after the carbon-carbon crosslinker is activated by imposing the noted second conditions of heat and pressure to further crosslink the polymeric material and/or sterilize the implant. In some embodiments the UHMWPE containing both crosslinker and antioxidant is irradiated to further cross-link the material and/or sterilize the implant. Irradiation can be done by ionizing irradiation, specifically by electron beam or gamma irradiation. Irradiation temperature can be below, at or above the melting temperatures of the polymeric material or blends of the polymeric material with the antioxidant(s) and/or peroxide(s).

Gamma irradiation or electron irradiation—the latter called e-beam or electron beam (ir)radiation interchangeably—can be used. In general, gamma irradiation results in a higher radiation penetration depth than electron irradiation. Gamma irradiation generally provides a low radiation dose rate and requires a longer duration of time, which can result in more in-depth and extensive oxidation, particularly if the gamma irradiation is carried out in air. Oxidation can be reduced or prevented by carrying out the gamma irradiation in an inert gas, such as nitrogen, argon, or helium, or under vacuum. Electron irradiation, in general, results in more limited dose penetration depth, but requires less time and, therefore, reduces the risk of extensive oxidation if the irradiation is carried out in air. In addition, if the desired dose levels are high, for instance 20 MRad, the irradiation with gamma may take place over one day, leading to impractical production times. On the other hand, the dose rate of the electron beam can be adjusted by varying the irradiation parameters, such as conveyor speed, scan width, and/or beam power. With the appropriate parameters, a 20 MRad melt-irradiation can be completed in for instance less than 10 minutes. The penetration of the electron beam depends on the beam energy measured by million electron-volts (MeV). Most polymers have a density of about 1 g/cm³, which leads to the penetration of about 1 centimeter with a beam energy of 2-3 MeV and about 4 centimeters with a beam energy of 10 MeV. If electron beam irradiation is preferred, the desired depth of penetration can be adjusted based on the beam energy. Accordingly, gamma irradiation or electron irradiation may be used based upon the depth of penetration preferred, time limitations and tolerable oxidation levels. Double-sided irradiation using electron beam can increase the overall thickness of the irradiated polymeric material.

In some embodiments a low energy electron beam is used to limit the effect of irradiation to a thin surface layer of the polymeric material. The polymeric material may be in any form. For instance it could be in the form of an implant preform or an implant to crosslink the polymeric material and/or sterilize the implant.

### Additional Treatments—Mechanical Deformation

Several pre- and post-crosslinking treatments can be utilized to improve the oxidation resistance, wear resistance, or mechanical strength of the polymeric material. For example, high pressure crystallization of UHMWPE leads to the formation of a hexagonal crystalline phase and induces higher crystallinity and higher mechanical strength in uncross-linked and cross-linked UHMWPE, more so in the presence of a plasticizing agent such as vitamin E. High pressure crystallization methods are described U.S. Patent Application Publication Nos. 2007/0265369 and 2007/0267030 to Muratoglu et al.

In some embodiments, the effective amount of antioxidant contained in an article made of polymeric material may be diminished after cross-linking, especially if the antioxidant is consumed by reacting with free radicals generated during crosslinking. To prevent oxidation on the antioxidant-poor region(s), the methods herein provide that the crosslinked polymeric material, medical implant preform or medical implant can be treated by using one or more of the following methods:
(1) mechanically deforming—or equivalently mechanical annealing—of the UHMWPE followed by heating below or above the melting point of the article;
(2) doping with antioxidant(s) through diffusion at an elevated temperature below or above the melting point of the cross-linked article;
(3) high pressure crystallization or high pressure annealing of the article; and
(4) further heat treating the article.
   After one or more of these treatments, free radicals induced by irradiation or chemical crosslinking are stabilized or practically eliminated everywhere in the article.

In some embodiments, mechanical annealing of crosslinked polymeric material can be performed. General methods for mechanical annealing of uncrosslinked and crosslinked polymeric materials, also in the presence of antioxidants and plasticizing agents are described in, for example, U.S. Pat. Nos. 7,166,650 and 7,431,874, and U.S. Patent Application Publication Nos. 2007/0265369 and 2007/0267030, the contents of which are incorporated herein by reference in their entirety. In another embodiment, invention provides methods to improve oxidative stability of polymers by mechanically deforming the irradiated antioxidant-containing polymers to reduce or eliminate the residual free radicals. General mechanical deformation methods have been described in, for example, U.S. Patent Publication Nos. 2004/0156879 and US 2005/0124718; and PCT Patent Application Publication No. WO 2005/074619, the contents of which are incorporated herein by reference in their entirety.

Some embodiments of the present invention also include methods that allow reduction in the concentration of residual free radical in irradiated polymer, even to undetectable levels, without heating the material above its melting point. This method involves subjecting an irradiated sample to a mechanical deformation that is below the melting point of the polymer. The deformation temperature could be as high as about 135° C., for example, for UHMWPE. The deformation causes motion in the crystalline lattice, which permits recombination of free radicals previously trapped in the lattice through crosslinking with adjacent chains or formation of trans-vinylene unsaturations along the back-bone of the same chain. If the deformation is of sufficiently small amplitude, plastic flow can be avoided. The percent crystallinity should not be compromised as a result. Additionally, it is possible to perform the mechanical deformation on machined components without loss in mechanical tolerance. The material resulting from the present invention is a cross-linked polymeric material that has reduced concentration of residuals free radical, and preferably substantially no detectable free radicals, while not substantially compromising the crystallinity and modulus.

Some embodiments of the present invention further provide that the deformation can be of large magnitude, for example, a compression ratio of 2. The deformation can provide enough plastic deformation to mobilize the residual free radicals that are trapped in the crystalline phase. It also can induce orientation in the polymer that can provide anisotropic mechanical properties, which can be useful in implant fabrication. If not desired, the polymer orientation can be removed with an additional step of heating at an increased temperature below or above the melting point.

According to another aspect of the invention, a high strain deformation can be imposed on the irradiated component. In this fashion, free radicals trapped in the crystalline domains likely can react with free radicals in adjacent crystalline planes as the planes pass by each other during the deformation-induced flow. High frequency oscillation, such as ultrasonic frequencies, can be used to cause motion in the crystalline lattice. This deformation can be performed at elevated temperatures that is below the melting point of the polymeric material, and with or without the presence of a sensitizing gas. The energy introduced by the ultrasound yields crystalline plasticity without an increase in overall temperature.

The present invention also provides methods of further heating following free radical elimination below melting point of the polymeric material. According to the invention, elimination of free radicals below the melt is achieved either by the sensitizing gas methods and/or the mechanical deformation methods. Further heating of cross-linked polymer containing reduced or no detectable residual free radicals is done for various reasons, for example:

1. Mechanical deformation, if large in magnitude (for example, a compression ratio of two during channel die deformation), will induce molecular orientation, which may not be desirable for certain applications, for example, acetabular liners. Accordingly, for mechanical deformation:

a) Thermal treatment below the melting point (for example, less than about 137° C. for UHMWPE) is utilized to reduce the amount of orientation and also to reduce some of the thermal stresses that can persist following the mechanical deformation at an elevated temperature and cooling down. Following heating, it is desirable to cool down the polymer at slow enough cooling rate (for example, at about 10° C./hour) so as to minimize thermal stresses. If under a given circumstance, annealing below the melting point is not sufficient to achieve reduction in orientation and/or removal of thermal stresses, one can heat the polymeric material to above its melting point.

b) Thermal treatment above the melting point (for example, more than about 137° C. for UHMWPE) can be utilized to eliminate the crystalline matter and allow the polymeric chains to relax to a low energy, high entropy state. This relaxation leads to the reduction of orientation in the polymer and substantially reduces thermal stresses. Cooling down to room temperature is then carried out at a slow enough cooling rate (for example, at about 10° C./hour) so as to minimize thermal stresses.

After diffusion of the crosslinking agent, or before or after high temperature melting, the final implant is packaged and sterilized by irradiation or gas sterilization. The implant preform or implant can be irradiated before or after the diffusion of the crosslinking agent, or before or after high temperature melting.

High temperature melting methods have been described by Oral et al. in PCT Patent Application Publication No. WO 2010/096771, which is incorporated herein by reference.

### Doping/Diffusion of Additives

In another embodiment, invention provides methods to improve oxidative stability of polymers by diffusing more antioxidant into the irradiated polymer-antioxidant blend. Antioxidant diffusion methods have been described, for example, in U.S. Patent Application Publication Nos. 2004/0156879 and 2008/0214692 and PCT Patent Application Publication No. WO 2007/024689, the contents of which are incorporated herein by reference in their entirety.

Diffusion and penetration depth in irradiated UHMWPE has been discussed. Muratoglu et al. (see U.S. Patent Application Publication No. 2004/0156879) described, among other things, high temperature doping and/or annealing steps to increase the depth of penetration of a-tocopherol into radiation cross-linked UHMWPE. Muratoglu et al. (see U.S. Patent Application Publication No. 2008/0214692) described annealing in supercritical carbon dioxide to increase depth of penetration of α-tocopherol into irradiated UHMWPE.

If the polymeric material has been consolidated without containing an antioxidant, or if it is desired to provide a consolidated material with antioxidant in addition to what was included in the powder blend before consolidation, the consolidated material can be doped with antioxidant. Doping of the polymeric material with an antioxidant can be done through diffusion at a temperature above the melting point of the irradiated polymeric material (for example, at a temperature above 137° C. for UHMWPE), or can be carried out under sub-ambient pressure, under ambient pressure, under elevated pressure, and/or in a sealed chamber. Doping above the melting point can be done by soaking the article in antioxidant at a temperature above 137° C. for at least 10 seconds to about 100 hours or longer. At elevated pressures, the melting point of polymeric material can be elevated, therefore temperature ranges ‘below’ and ‘above’ the melting point may change under pressure.

Polymeric material can be doped with an antioxidant by soaking the material in the additive, a mixture of additives or a solution of the additive. This allows the additive to diffuse into the polymer. For instance, the material can be soaked in 100% antioxidant. To increase the depth of diffusion, the material can be doped for longer durations, at higher temperatures, at higher pressures, and/or in presence of a supercritical fluid. The additive can be diffused to a depth of about 5 millimeters or more from the surface, for example, to a depth of about 3-5 millimeters, about 1-3 millimeters, or to any depth.

In various embodiments, doping involves soaking a polymeric material, medical implant or device with an additive for about half an hour up to several days, preferably for about one hour to 24 hours, more preferably for one hour to 16 hours. The additive or additive solution can be at room temperature or heated up to about 137° C. and the doping can be carried out at room temperature or at a temperature up to about 137° C. Preferably the additive solution is heated to a temperature between about 60° C. and 120° C., or about 100° C. and 135° C. or between about 110° C. and 130° C., and the doping is carried out at a temperature between about 60° C. and 135° C. or between about 60° C. and 100° C.

Doping with additive(s) through diffusion at a temperature above the melting point of the irradiated polyethylene (for example, at a temperature above 137° C.) can be carried out under reduced pressure, ambient pressure, elevated pressure, and/or in a sealed chamber, for about 0.1 hours up to several days, preferably for about 0.5 hours to 6 hours or more, more preferably for about 1 hour to 5 hours. The additives or additive solution can be at a temperature of about 137° C. to about 400° C., more preferably about 137° C. to about 200° C., more preferably about 137° C. to about 160° C.

In an embodiment, doping is carried out at temperatures below those at which the crosslinker is activated. Steps can be followed by an additional step of “homogenization”, which refers to a heating step in air or in anoxic environment to improve the spatial uniformity of the additive concentration within the polymeric material, medical implant or device. Homogenization also can be carried out after any doping step. The heating may be carried out above or below or at the peak melting point. Preferably, the homogenization is carried out at 0° C. to 400° C., or at 30° C. to 120° C. or at 90° C. to 180° C., more preferably 80° C. to 100° C. Homogenization is preferably carried out for about one minute to several months, one hour to several days to two weeks or more, more preferably about 1 hour to 24 hours or more, more preferably about 4 hours. In an example, the homogenization is carried out at about 100° C. for about 4 hours or at about 120° C. for about 4 hours. The polymeric material, medical implant or device is kept in an inert atmosphere (nitrogen, argon, and the like), under vacuum, or in air during the homogenization process. The homogenization also can be performed in a chamber with supercritical fluids such as carbon dioxide or the like. The pressure of the supercritical fluid can be about 1000 to about 3000 psi or more, more preferably about 1500 psi. It is also known that pressurization increases the melting point of UHMWPE. A higher temperature than 137° C. can be used for homogenization below the melting point if applied pressure has increased the melting point of UHMWPE.

### Measurement of Crosslinking

The extent of crosslinking can be measured and quantified by determining the trans-vinylene index. Following crosslinking, the crosslinked UHMWPE construct is machined in half and microtomed. The microtomed thin section is then analyzed using an infrared microscope with an aperture size of 100 μm by 50 μm as a function of depth at 1 mm increments. Each individual infrared spectrum is then analyzed by normalizing the area under the trans-vinylene vibration at 965 cm⁻¹ to that under the 1900 cm⁻¹ band after subtracting the respective baselines. The value obtained is the trans-vinylene index (TVI), which is proportional to the level of crosslinking.

### EXAMPLES

### Example 1

From 0.01 up to 10 parts of crosslinker are combined with UHMWPE powder to make 100 parts. The blend is consolidated at elevated pressure and a temperature above the peak melting temperature of the UHMWPE. After consolidation, the consolidated blend is subjected to a temperature of about 200° C. up to about 320° C. to activate the crosslinker. The temperature is maintained under ambient pressure conditions and is held for up to 360 minutes to activate the crosslinker and crosslink the consolidated UHMWPE.

### Example 2

1 part Perkadox 30 and 99 parts UHMPWE were consolidated at 185° C. in a mold for 15 minutes at a pressure of 12 MPa, followed by a ramp up to 275° C. for 180 minutes to react the Perkadox and crosslink. This resulted in significant crosslinking of the polymer (as measured with FTIR and determining the trans-vinylene index).

### Non-Limiting Discussion of Terminology

The headings (such as “Introduction” and “Summary,”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof. Similarly, subpart headings in the Description are given for convenience of the reader, and are not a representation that information on the topic is to be found exclusively at the heading.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make, use and practice the compositions and methods of this invention and, unless explicitly stated otherwise, are not intended to be a representation that given embodiments of this invention have, or have not, been made or tested.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

Throughout the specification, “conditions of heat and pressure” “conditions of temperature and pressure,” “conditions of pressure and heat,” conditions of pressure and temperature,” and similar phrases are intended to be synonymous.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein. Further, as used herein the term “consisting essentially of” recited materials or components envisions embodiments “consisting of” the recited materials or components.

A″ and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

As referred to herein, ranges are, unless specified otherwise, inclusive of endpoints and include disclosure of all distinct values and further divided ranges within the entire range. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

We claim:

1. A method of preparing a crosslinked oxidation resistant ultrahigh molecular weight polyethylene for use in making a bearing component of an artificial joint implant, comprising:
forming a blend comprising UHMWPE powder and crosslinker;
applying first conditions of pressure and heat at a first temperature to consolidate the UHMWPE; and
applying second conditions of pressure and heat at a second temperature to activate the crosslinker and crosslink the consolidated UHMWPE;
wherein the second temperature is higher than the first temperature and the crosslinker is activated at the second temperature,
wherein the crosslinker comprises a carbon-carbon initiator that is free of peroxide groups and capable of thermally decomposing under the second conditions of heat and pressure into carbon-based free radicals by breaking at least one carbon-carbon single bond.

2. The method according to claim 1, wherein the conditions of pressure and heat at the first temperature comprise direct compression of the blend to the final shape of the bearing component.

3. The method according to claim 1, further comprising machining the bearing component from the crosslinked consolidated UHMWPE.

4. The method according to claim 1, wherein the crosslinker comprises a high temperature carbon based initiator represented by the structure: 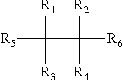
where R₁, R₂, R₃, and R₄, are independently selected from hydrogen and hydrocarbyl, R₅ and R₆ are independently selected from aryl and substituted aryl.

5. The method according to claim 4, wherein at least two of R₁, R₂, R₃, and R₄ are not hydrogen.

6. A method according to claim 4, wherein R₁, R₂, R₃, and R₄ are independently selected from C₁₋₆-alkyl.

7. A method according to claim 4, wherein R₁, R₂, R₃, and R₄ are independently selected from C₁₋₃-alkyl.

8. A method according to claim 4, wherein R₁, R₂, R₃, and R₄ are methyl.

9. A method according to claim 4, wherein R₅ and R₆ are independently selected from phenyl and substituted phenyl.

10. A method according to claim 4, wherein the first temperature is below 210° C. and the second temperature is above 220° C.

11. The method according to claim 1, wherein the blend further comprises an antioxidant.

12. A method according to claim 10, wherein the antioxidant comprises a vitamin E compound.

13. A method according to claim 10, wherein the antioxidant comprises a hindered amine light stabilizer.

14. The method according to claim 1, further comprising doping antioxidant into the consolidated UHMWPE.

15. The method according to claim 1, further comprising irradiating the consolidated UHMWPE or irradiating the crosslinked and consolidated UHMWPE.

16. A method of preparing an oxidation-resistant crosslinked polymer, comprising:
forming a blend comprising the polymer, antioxidant, and crosslinker;
applying first conditions of pressure and heat at a first temperature to consolidate the blend; and
applying second conditions of pressure and heat at a second temperature to activate the crosslinker and crosslink the consolidated blend;
wherein the second temperature is higher than the first temperature and the crosslinker is activated at the second temperature,
wherein the crosslinker comprises a carbon-carbon initiator that is free of peroxide groups and capable of thermally decomposing under the second conditions of heat and pressure into carbon-based free radicals by breaking at least one carbon-carbon single bond.

17. The method according to claim 15, wherein the crosslinker comprises a compound represented by the structure: 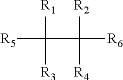
wherein R₁, R₂, R₃, and R₄ are independently selected from hydrogen and hydrocarbyl, R₅ and R₆ are independently selected from aryl and substituted aryl, and at least two of R₁, R₂, R₃, and R₄ are not hydrogen.

18. A method according to claim 16, wherein R₁, R₂, R₃, and R₄ are independently selected from C₁₋₆-alkyl.

19. A method according to claim 16, wherein R₁, R₂, R₃, and R₄ are independently selected from C₁₋₃-alkyl.

20. A method according to claim 16, wherein R₁, R₂, R₃, and R₄ are methyl.

21. A method according to claim 16, wherein R₅ and R₆ are independently selected from phenyl and substituted phenyl.

22. A method according to claim 15, wherein the first temperature is below 250° C. and the second temperature is above 200° C.

23. A method according to claim 15, wherein the antioxidant is selected from chemical compounds that activate to produce a nitroxyl radical.

24. A method according to claim 15, wherein the antioxidant comprises a vitamin E compound.

25. A method according to claim 15, wherein the antioxidant comprises a hindered amine light stabilizer.

26. A method according to claim 15, wherein applying the first conditions comprises heating a temperature greater than 200° C.

27. A method according to claim 15, wherein applying the first conditions comprises compression molding the blend.

28. The method according to claim 15, wherein the polymer is ultrahigh molecular weight polyethylene.

29. A method of preparing a crosslinked ultrahigh molecular weight polyethylene for use in making a bearing component of an artificial joint implant, comprising:
forming a blend comprising UHMWPE powder, a hindered amine light stabilizer, and crosslinker;
applying first conditions of pressure and heat at a first temperature to consolidate the blend; and
applying second conditions of pressure and heat at a second temperature to activate the crosslinker and crosslink the consolidated blend;
wherein the second temperature is higher than the first temperature and the crosslinker is activated at the second temperature,
wherein the crosslinker comprises a compound represented by the structure: 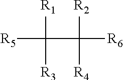
wherein R₁, R₂, R₃, and R₄ are independently selected from hydrogen and hydrocarbyl, R₅ and R₆ are independently selected from aryl and substituted aryl, and at least two of R₁, R₂, R₃, and R₄ are not hydrogen.

30. The method according to claim 29, wherein the first conditions include a temperature above 150° C. and below 210° C.

31. The method according to claim 29, wherein the second conditions include a temperature above 220° C.

32. The method according to claim 29, wherein consolidating the blend comprises direct compression molding.

33. The method according to claim 29, wherein the first conditions comprise compression molding.

34. The method according to claim 29, wherein consolidating the blend comprises ram extrusion of the blend.

35. The method according to claim 29, further comprising subjecting a consolidated UHMWPE to gamma or electron beam irradiation.

36. The method according to claim 29, wherein the blend comprises 0.1-2% by weight of the hindered amine light stabilizer and 0.1-5% by weight of the crosslinker.
